(19) United States
(12) Patent Application Publication
(10) Pub. No.: US 2006/0016719 A1
(43) Pub. Date: Jan. 26, 2006

(54) Containers and serving trays for snack foods

(75) Inventors: Joseph D. Cassese, Hoboken, NJ (US); James Hicswa, Saddle Brook, NJ (US)

Correspondence Address: BANNER & WITCOFF, LTD., TEN SOUTH WACKER DRIVE, SUITE 3000, CHICAGO, IL, 60606, US

(73) Assignee: The PopCup Company LLC, Hoboken, NJ (US)

(21) Appl. No.: 11/187,287

(22) Filed: Jul. 22, 2005

Related U.S. Application Data
(60) Provisional application No. 60/665,284, filed on Mar. 25, 2005.
(60) Provisional application No. 60/602,923, filed on Aug. 19, 2004.
(60) Provisional application No. 60/591,247, filed on Jul. 26, 2004.

(51) Int. Cl. A21D 10/02; B65D 3/00; B65D 1/34

(52) U.S. Cl. 206/564; 229/400; 426/111; 426/115

(57) ABSTRACT

A snack holder includes a generally cylindrical cup sized and shaped lower section and a larger container or multiple container upper or adjacent section for holding snack foods, additional cups and the like.

### CROSS REFERENCE TO RELATED APPLICATIONS

This is a utility application based upon, incorporating by reference and claiming priority to the following provisional applications: Ser. No. 60/591,247 filed Jul. 26, 2004 entitled “Container for Snack Foods”; Ser. No. 60/602,923 filed Aug. 19, 2004 entitled “Container for Snack Foods”; and Ser. No. 60/665,284 filed Mar. 25, 2005 entitled “Containers and Serving Trays for Snack Foods”.

### BACKGROUND OF THE INVENTION

In a principal aspect, the present invention relates to containers, cup holders and trays for snack foods which may be utilized by placement in a cup holder in a vehicle or in the arm of a theatre seat, for example.

When attending a movie theatre, entertainment venue or when driving a vehicle, snack food items are often purchased by the patron or driver or otherwise made available. Placement of these snack foods in a sack or box, or other similar container may be distracting and may also be inefficient or cumbersome. As a consequence, various product designs to accommodate such issues have been proposed. For example, combined food and beverage containers and trays have been proposed as illustrated or disclosed in the following listing of patents:

| Patent No. | Inventor | Issue Date | Title |
|---|---|---|---|
| 1,665,289 | Weaver | Apr. 10, 1928 | Means for Serving Food |
| | | | and Drink |
| 3,285,495 | Colato | Nov. 15, 1966 | Reusable Food Package |
| | | | with Integral |
| | | | Adjustable Closure |
| 3,288,344 | Woollen | Nov. 29, 1966 | Double Container |
| | et al. | | Dispensing Package |
| Des. | Ludwick | Oct. 7, 1986 | Combined Food and |
| 285,999 | | | Beverage Container |
| 4,779,998 | Wischusen | Oct. 25, 1988 | Composite Bag-Like Package |
| 5,180,079 | Jeng | Jan. 19, 1993 | Combined Cup |
| 5,573,131 | Berjis | Nov. 12, 1996 | Apparatus for Forming |
| | | | a Container to Hold a |
| | | | Drinking Cup at the |
| | | | Bottom End of the |
| | | | Container and to Hold |
| | | | Food in the Upper |
| | | | Portion of the Container |
| Des. | Waldmann | Sep. 8, 1998 | Combined Beverage and |
| 397,911 | | | Snack Holder |
| 6,182,890 | Sattler | Feb. 6, 2001 | Collapsible Container |
| B1 | et al. | | for Holding Foodstuffs, |
| | | | and Methods of Using |
| | | | Same |

Such constructions typically call for the inclusion of a lower drink portion in the form of a cup and an upper snack food portion positioned over the lower portion. A straw typically provides access to the liquid lower portion. The upper portion typically includes an open top for manual access. Certain prior art patents suggest that a lower cup portion be shaped to fit into a cup holder.

Various other patents are directed to this general subject matter including the following:

| Patent No. | Inventor | Issue Date | Title |
|---|---|---|---|
| Publication No. | Frank et al. | Oct. 10, 2002 | Bottomless Bag |
| 2002/0145295 | | | |
| 421,264 | Gibbons | Feb. 11, 1890 | Party Plate |
| 1,881,416 | Uhalt | Oct. 4, 1932 | Meal Serving Mat |
| 2,036,687 | C. Fisher | Apr. 7, 1936 | Moistureproof Bag |
| 2,301,216 | Koontz | Nov. 10, 1942 | Bottle Holder |
| 3,148,636 | Bloomquist | Sep. 15, 1964 | Serving Tray |
| | et al. | | |
| 3,401,858 | White et al. | Sep. 17, 1968 | Service Tray |
| 3,422,986 | Tilseth | Jan. 21, 1969 | Dish Lip Plate |
| | | | Attachment |
| 4,219,144 | Hagelberg | Aug. 26, 1980 | Serving Tray |
| 4,461,396 | Harper | Jul. 24, 1984 | Combined Plates and |
| | | | Glass Holders |
| 4,534,469 | Elsmo | Aug. 13, 1985 | Tray Assembly |
| 4,607,758 | Stevens | Aug. 26, 1986 | Serving Tray |
| 4,744,597 | Bauman et al. | May 17, 1988 | Food and Beverage |
| | | | Tray |
| 4,836,970 | Robbins | Jun. 6, 1989 | Method of Extrusion |
| | | | Blow-Molding |
| | | | Container Having |
| | | | Upper and Lower |
| | | | Sections of |
| | | | Different Thickness |
| 4,989,742 | Powell | Feb. 5, 1991 | Tray Apparatus |
| 5,100,607 | Robbins | Mar. 31, 1992 | Blow-Molding |
| | | | Methods to Form |
| | | | Containers Having |
| | | | Upper and Lower |
| | | | Sections of Different |
| | | | Thickness |
| 5,111,960 | Zilliox | May 12, 1992 | Interlocking Plate |
| | | | and Cup Set |
| 5,184,750 | Moller | Feb. 9, 1993 | Party Dish |
| 5,323,910 | van de | Jun. 28, 1994 | Party Plate |
| | Graaf, Jr. | | |
| 5,390,798 | Yanuzzi | Feb. 21, 1995 | Food and Beverage |
| | | | Support Tray with |
| | | | Beverage Vessel |
| | | | Cutout |
| 5,425,455 | Miller et al. | Jun. 20, 1995 | Folding Lap Tray |
| 5,497,885 | Sussman | Mar. 12, 1996 | Lap Tray for Carrying |
| | | | Food |
| 5,542,577 | Friedrich | Aug. 6, 1996 | Plate Assembly |
| | | | Gripping Member |
| 5,780,824 | Matos | Jul. 14, 1998 | Expandable and Self- |
| | | | Venting Novelty |
| | | | Container for Cooking |
| | | | Microwave Popcorn |
| 6,021,914 | Schmidt | Feb. 8, 2000 | Hors D'oeuvre Tray |
| 6,149,027 | Rathjen | Nov. 21, 2000 | Combination Food |
| | | | Plate and Beverage- |
| | | | Container-Holder |
| | | | Article |
| 6,382,449 | Kazmierski | May 7, 2002 | Two Stage Cup |
| B1 | et al. | | |
| 6,586,715 | Watkins | Jul. 1, 2003 | Microwavable |
| B2 | | | Container for Food |
| | | | Products and Method |
| | | | of Fabricating |
| | | | Same |

Nonetheless, the availability of serving trays and cup holders for holding snack foods and/or retention thereof in a cup holder has been somewhat limited. The present invention is directed to various unique designs.

### SUMMARY OF THE INVENTION

Briefly, the present invention comprises various designs for snack holders, cup containers and serving trays. In one embodiment a cup shaped container includes a bottom section or panel that is formed so as to be easily inserted and retained in a cup holder. The cup holder may, of course, be located in a theatre seat or other furniture or in a vehicle and typically comprises an opening for receipt of a circular cross section cup and optionally a support surface for supporting the bottom of the cup. Thus, the holder may comprise a circular opening only and support a cup by frictionally engaging the side of the cup.

Various alternative designs of snack container and serving tray devices, as well as methods for manufacture and assembly of such containers are disclosed. For example, a container may comprise a circular cross section lower cup shaped element connected to and supporting a generally larger, cone shaped or rectangular cross section upper element. The upper element may comprise a semi-rigid sided container or a bag. The container or bag may include a cover or top. Snack items may be pre-packaged in the container or added. The devices may be assembled from a folded flat configuration. Serving trays may incorporate a cup holder feature and multiple openings for holding snacks or containers of various sizes.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of a first embodiment of the invention;

FIG. 2 is an isometric view of a second embodiment of the invention;

FIG. 3 is an isometric view of a third embodiment of the invention;

FIG. 4 is an isometric view of a fourth embodiment of the invention and further depicting a method of manufacture associated therewith;

FIG. 5 is an isometric view depicting another version of the invention and a method of manufacture;

FIG. 5A is an isometric view depicting the embodiment of FIG. 5 in a folded condition;

FIG. 6 is an isometric view depicting a further alternative embodiment of the invention and an associated method of manufacture;

FIG. 6A is a plan view of a section of the embodiment of FIG. 6;

FIG. 7 is an isometric view illustrating a further embodiment of the invention especially useful for microwave popcorn as a snack food;

FIG. 7a is a further isometric view of the embodiment of FIG. 7;

FIG. 8 illustrates a further embodiment of the invention wherein the snack food comprises microwave popcorn illustrating the manner of application of the invention to a fully popped snack;

FIG. 9 is an isometric view of illustrating the embodiment of FIG. 8;

FIG. 10 is an isometric view illustrating an alternative embodiment of the invention;

FIG. 11 is an isometric view of yet a further embodiment of the invention utilizing a paper or cardboard material;

FIG. 12 is another embodiment of the invention similar to the embodiment to FIG. 11 wherein the product is manufactured from a molded plastic material.

FIG. 13 is an isometric view of an alternative embodiment of the product tray and cup holder illustrated in position in a an arm of a theater seat;

FIG. 14 is an isometric view of the tray of FIG. 13 illustrating the manner of placement of product of snack foods and drinks in the tray of FIG. 13;

FIG. 15 is another alternative embodiment of the invention in an isometric view;

FIG. 16 is an isometric view of the embodiment of FIG. 15 having a snack food products positioned in the tray of FIG. 15;

FIG. 17 is a top plan view of the embodiment of FIG. 15 illustrating the manner in which the product may be manufactured and configured;

FIG. 18 is an isometric view of a further embodiment of the invention including an exploded isometric view illustrating a feature of the invention for retaining the food tray or container in position in a cup holder;

FIG. 19 is an isometric view of the container or tray of FIG. 18 with snack food products placed therein;

FIG. 20 is a top plan view of the embodiment of FIG. 18 in combination with a second example thereof illustrating the manner in which the product may be manufactured;

FIG. 21 is a plan view of another embodiment depicting the pattern for the embodiment;

FIG. 22 is an isometric view of the embodiment formed from the pattern of FIG. 21;

FIG. 23 is a plan view of another embodiment depicting a pattern for the embodiment; and

FIG. 24 is an elevation of the assembled embodiment of FIG. 23.

### DESCRIPTION OF THE PREFERRED EMBODIMENT

In general, the various types of snack food containers within the scope of the invention incorporate a bottom panel or lower side which is formed or shaped to fit into a cup holder, for example, at a theatre or entertainment venue. Multiple variations of this concept are disclosed. Variations contemplate, inter alia, forms of the lower base or cup portion of the product or device, methods for attaching or incorporating the cup shaped lower base to an upper container, variations of the form and shape of snack food container itself as used in combination with the lower cup shaped base, and use of a cup shaped base with a snack food package, such as a microwave popcorn package, wherein the microwave popcorn package contents may be subsequently processed. Consequently, there are many variations of the invention incorporating the general concept of a shaped base member capable of being inserted into a cup holder and a container portion associated with and mounted with or attached to the base member.

The upper container portion may have a generally flexible design fabricated from paper materials, for example. The upper container portion may also be of limited flexibility made, for example, from various grades of cardboard, plastic or other similar materials. The upper portion may be in the form of a bag or container which contains snack foods that are already packaged and maintained within secondary packaging in the container or covered by a removable cover sheet or replaceable top or cover to assure freshness. The upper container may be adapted to include food products or snacks which are not fully processed, for example, microwave popcorn products. In such an event, the upper container section may be sealed and may be folded in order to accommodate storage, packaging and transportation. Additionally, the entire assembly may be formed from plastic or other formable materials using molding techniques to form the container or package. The container may include instructions, advertising or other indicia. The interior of the containers may be appropriately coated to assure product freshness. Again, many combinations and permutations of the invention are disclosed.

Referring to the figures therefore, FIG. 1 illustrates a flexible paper bag upper container 20 with a lower base 22 attached to a bottom panel 21 of the upper container 20. The lower base 22 may be in the form of a premolded plastic cup or a preformed paper cup, for example. Of course, the containers such as the top container 20 in FIG. 1 may be of a variety of materials, sizes and shapes. The lower base cup portion 22 is preferably a standard size which will fit within a cup holder.

FIG. 2 illustrates an alternative embodiment wherein an upper container section 24 is made from a stiff cardboard construction, for example, and the lower base or cup portion 26 is fabricated from a treated paper material and is attached by an adhesive to the base 25 of section 24.

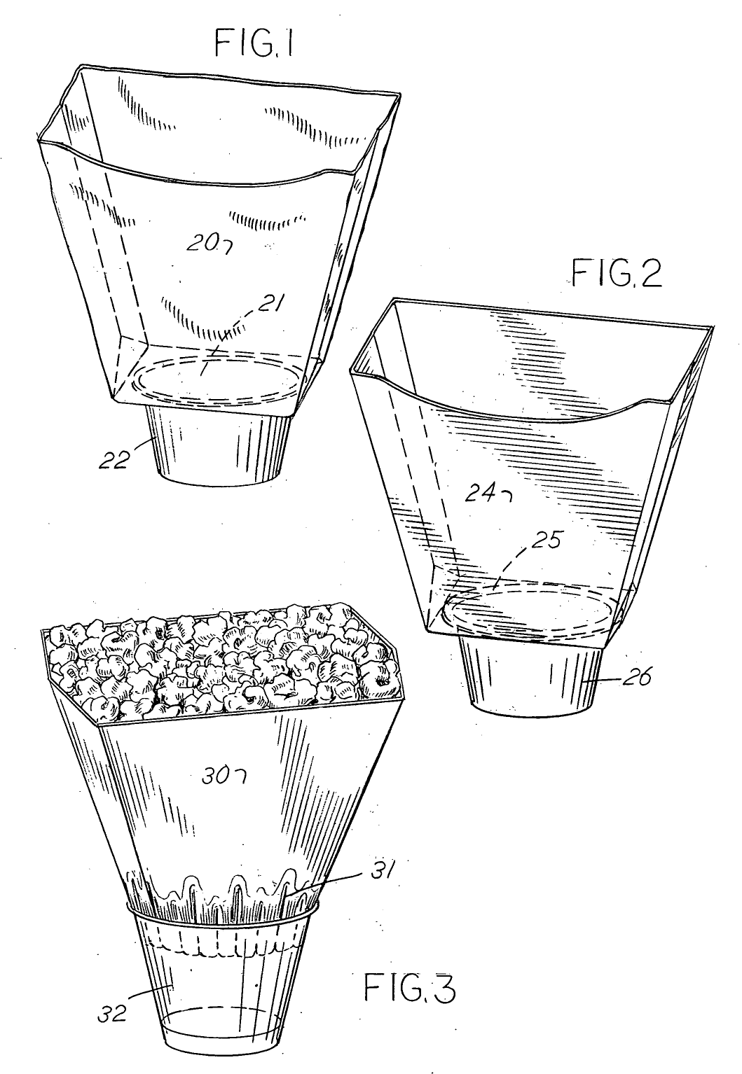

FIG. 3 illustrates the construction wherein an upper container 30 has a configuration which is generally truncated and designed to fit within a lower base or cup section 32. That is, the upper container includes multiple folds or crimped portions 31 and is fitted into and attached to the lower section 32. The upper section or container section 30 may be preassembled with the lower section 32 or unfolded from a flat storage condition and inserted into a lower section at a dispensing or point of sale station. The upper section may include printing or indicia on the outside surface. It may be coated with an interior wax layer to facilitate freshness and maintaining ingredients in the container.

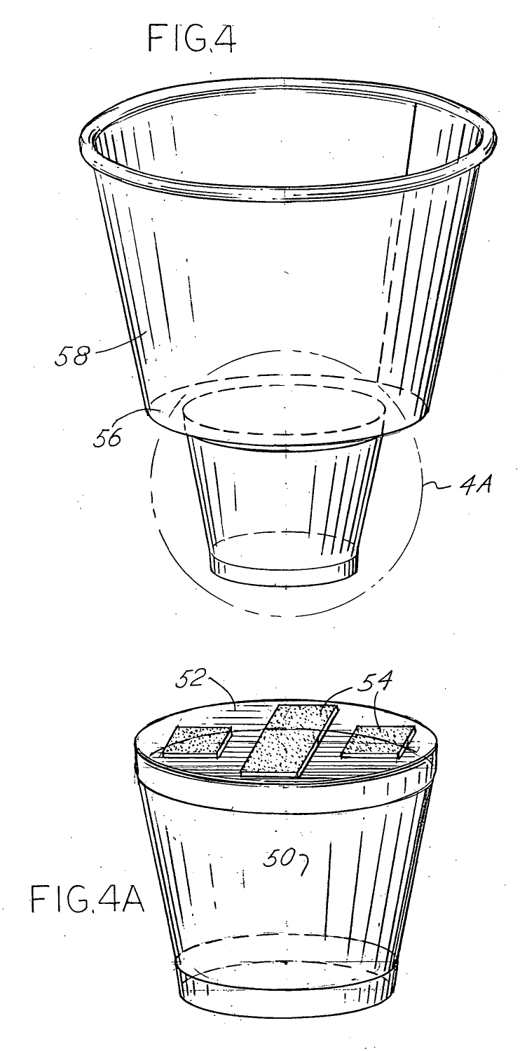

FIG. 4 depicts yet another embodiment wherein a lower cup shaped base 50 includes a panel 52 with adhesive strips 54 or other attachment elements that attach to the lower base 56 of a tub type container 58. The cup base 50 has a configuration which will fit within a cup holder.

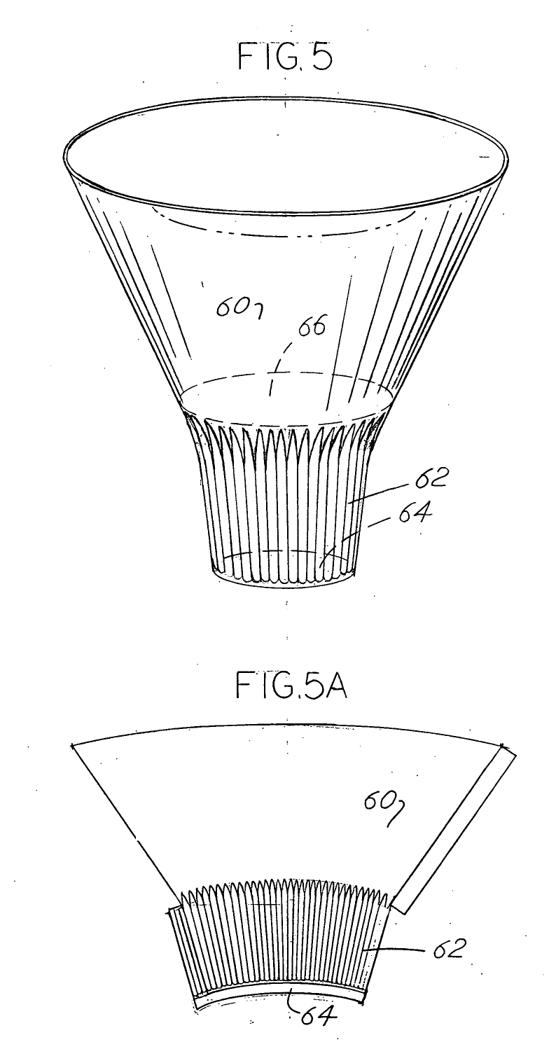

FIG. 5 depicts a single piece design wherein a frustoconical upper container section 60 includes a lower base section 62 in the shape of a cup. The container may have a bottom panel 64. Alternatively, a bottom panel 66 may be provided or formed within the frustoconical cone section 60. The embodiment may be folded as depicted in FIG. 5A.

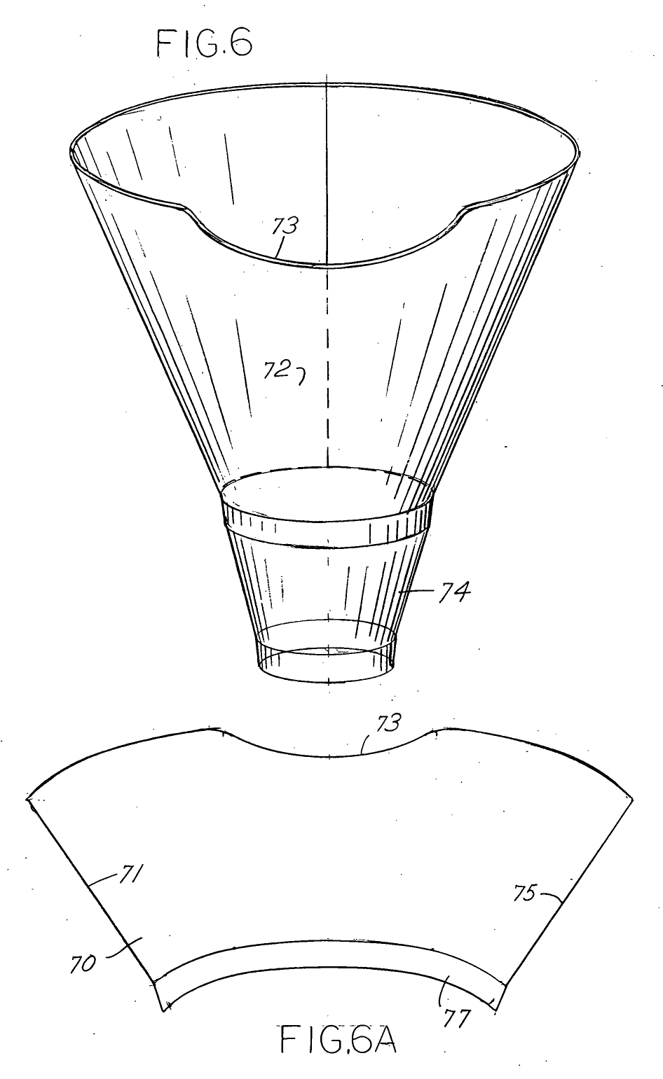

FIG. 6 illustrates a further embodiment wherein a section of planar cardboard or other material is cut and folded or formed as depicted in the figure to form a frustoconical container 72 which may be attached or inserted or coupled with a base section 74. An arcuate detent 73 facilitates access to the contents of container 72. FIG. 6A depicts the pattern for the container 72 which comprises an arcuate shape with sides 71, 75 that may be joined to form a seam. A lower margin is provided to affix to the top of cup 74.

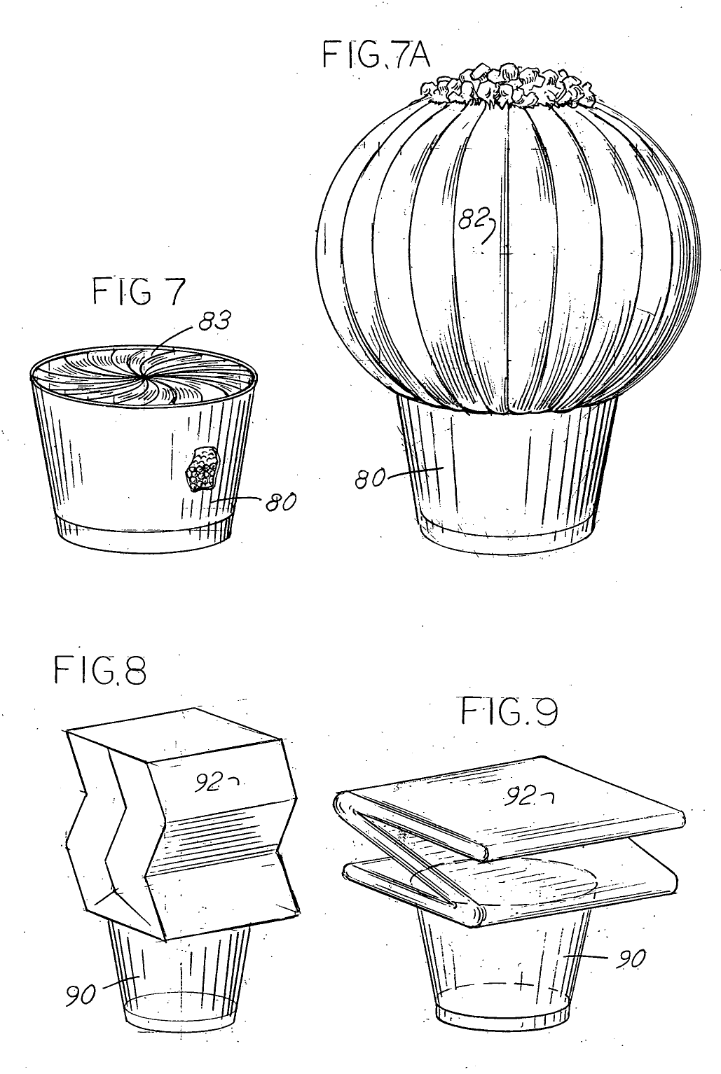

FIGS. 7 and 7A illustrate a combination wherein a cup section 80 is sized to fit within a cup holder and includes an expandable and/or removable cover 83, so that microwave popcorn product, which upon placement in a microwave oven, will expand cover 83 to form an upper container 82 while the lower base cup shaped section 80 serves to hold the snack filled container 82 within a cup holder.

FIGS. 8-10 depict an embodiment of the invention wherein a cup section 90 is combined with an expandable bag section 92. The bag section 92 is typically folded as shown in FIG. 9 prior to popping of a microwave corn product within the bag 92. The cup 90 or base 90 may be open to the package 92 as depicted in FIGS. 8 and 9. Alternatively, it may be merely attached to a portion or flap 94 of the package as depicted in FIG. 10. Thus, in the embodiment of FIG. 10, a standard microwave style microwave popcorn bag will have the additional feature of a cup member or cup base 90 attached thereto.

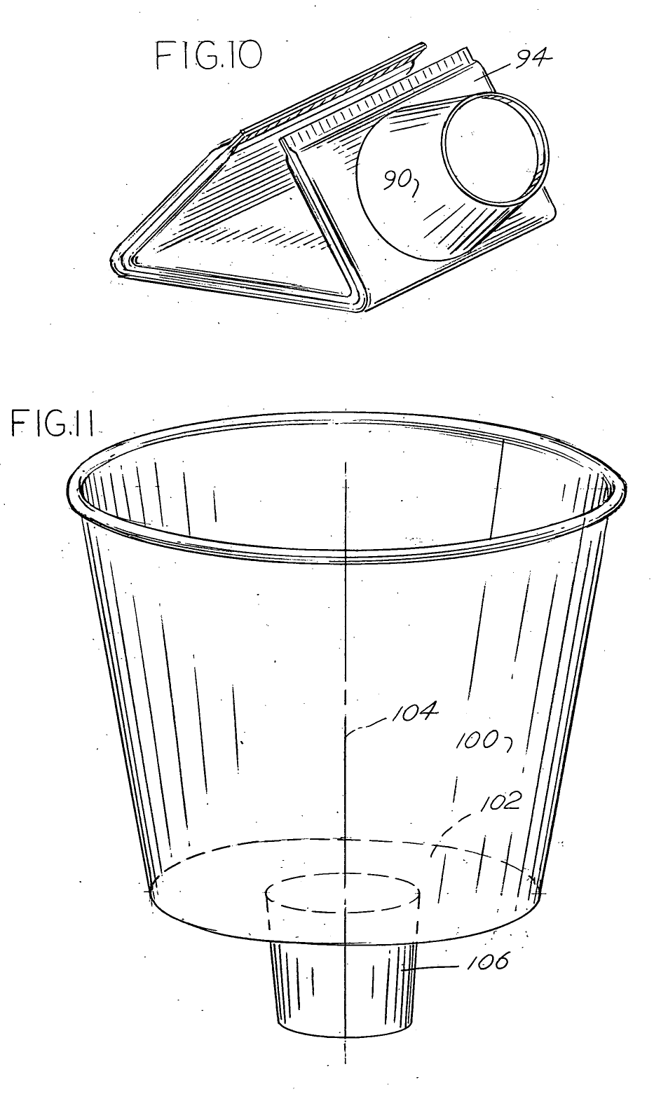

FIGS. 11 and 12 set forth an embodiment of the invention which incorporates a large standard-sized tub or container for popcorn or other snack foods in combination with a standard-sized cup which is attached to the underside or bottom side of the container. FIG. 11 is a version wherein the component parts are manufactured from wax coated cardboard paper. FIG. 12 is directed to an embodiment of the invention wherein the item is a molded plastic item.

Thus, referring to FIG. 11, a tub or container 100 has a generally cylindrical shape and includes a formed bottom surface 102. The tub or container 100 has a centerline axis or axis of rotation or cylindrical axis 104. Attached to the underside or bottom panel 102 of the container 100 is a standard-sized cup or lower portion of a cup 106. Attachment may be effected by adhesive for example. The centerline axis 104 of the cup 106 is aligned with the axis 104 so that the container will have symmetry and be less likely to spill or fall from a cup holder. It is to be noted, however, that the lower cup portion 106 may be positioned at various other parts of the lower or underside panel 102 to provide desired positioning of the container. Additionally, more than a single cup element 106 may be attached to the underside panel 102 of the container in the event that the cup holder associated with the motor vehicle, movie theater seat or the like includes more than one cup holder receptacle arrayed next to each other, or for positioning the container off center with respect to the cup holder.

In FIG. 12, a container or tub 110 includes a molded plastic base or bottom panel 112 and has attached thereto or molded therewith a lower cup-sized base section 114. Again, in the preferred embodiment the axis or centerline axis 116 of the tub or container 110 is aligned with the centerline axis of cup section 114.

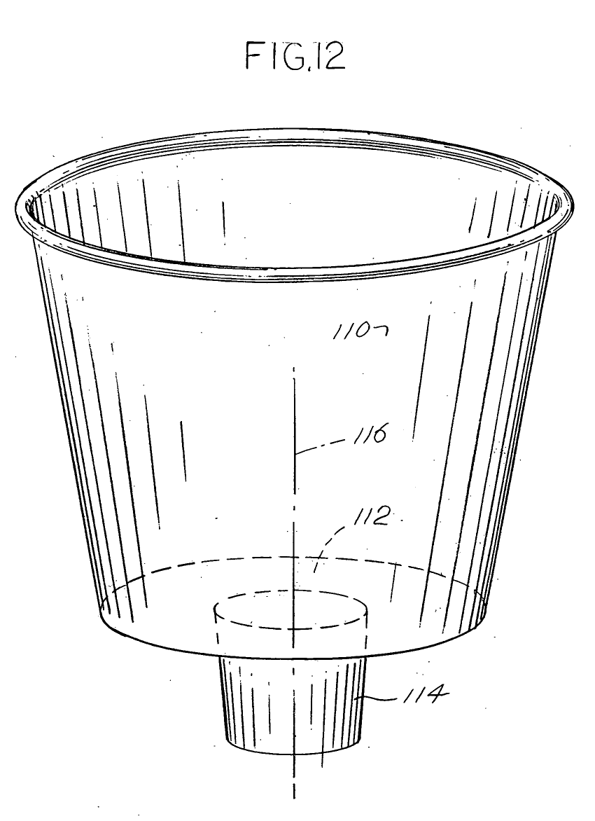

FIGS. 13 and 14 illustrate a further embodiment of the invention. In this embodiment a molded or formed tray 150 includes a central web 152 with a generally cylindrical, central opening 154 for receipt, for example, of a cup or a generally congruent or compatible snack food holding item such as the popcorn box 156 in FIG. 14. The central web 152 further includes a recess opening 158 for snack foods such as a candy bar 160 as depicted in FIG. 14. Projecting from the center web 152 laterally is a first wing 162. Projecting in the opposite direction is a second wing 164. The wings 162 and 164 include respectively a molded passage or opening 166 and 168. The openings 166 and 168 include a generally cylindrical side wall, such as side wall 170, and a bottom surface such as the bottom surface 172. The projecting lateral side wings 164 and 162 are maintained in the lower elevation relative to the web 152. That is, there is a transition section such as the transition section 174. The transition section 174 in combination with the second transition section 176 forms a groove which accommodates that arm 178 of a theatre seat for example. This enhances the maintenance of the position of the food tray construction depicted in FIG. 13.

Thus as illustrated in FIG. 14 drink containers, such as containers 182 and 184, can be placed in the respective cup holders 166 and 168. The identified groove in the center of the tray assembly in combination with the depending sections 174 and 176 will tend to hold the tray in a fixed position on the arm 178 even when a filled cup 182 is removed from one side of the tray. In other words, the tray is designed to maintain balance even when items are removed therefrom. Further, the various cylindrical openings 166, 168 and 154 enable placement of various types of food containers therein. Also, the configuration of various openings or passages in the tray assembly may be configured in any desired shape although the center 154 preferably generally cylindrical with a draft. That is, the side walls of the cylindrical passage are inclined inwardly in a slight manner to facilitate holding the containers that are placed therein and to conform in general to the shape of those containers. Such a draft construction is utilized with respect to any of the openings provided in the tray as described as a preferred feature of the inventions.

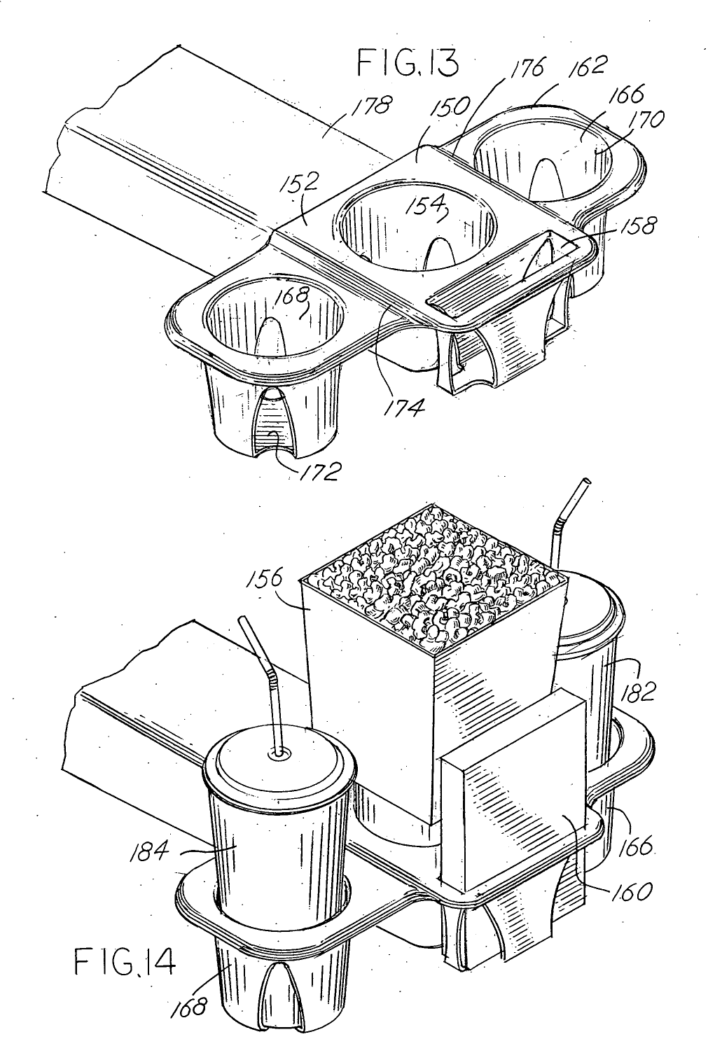

FIGS. 15, 16 and 17 illustrate a further embodiment of the invention. In this embodiment which is fabricated from a molded plastic or wax covered paper material, the configuration of the tray 200 is such that a web 202 includes a first generally cylindrical drink or cup containing section 204, and the second similarly shaped section 206 with a rectangular opening to a rectangular parallelepiped section 208. Thus, a drink container or cup 210 may be positioned in the opening 204. A snack container 212 in the opening 206 and a package for candy, for example, package 214 in the opening 208. The center section 204 would preferably be placed in a cup holder and arm rest by way of example although it is possible to position the cup shaped section 206 in such an arm holder.

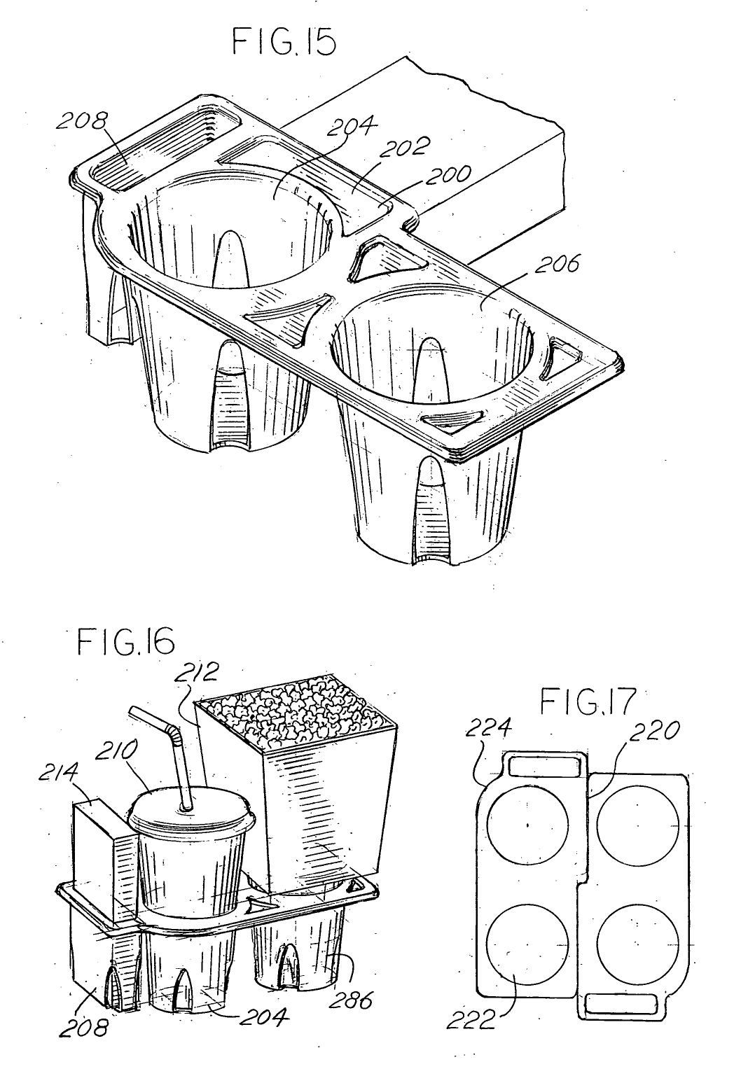

FIG. 17 illustrates the manner in which the embedment of FIG. 15 can be manufactured in a molding process wherein two such embodiments are molded with a tear line 220 separating the separate embodiments. The tear line 220 may be a perforated line or connection between the embodiments 222 and 224. Thus, the embodiments may be utilized for serving as well as any cup holder and snack holder for use in association with a theatre seat, for example. That is, if one is entertaining the configuration of FIG. 17 may be used to facilitate service of drink items and other snacks.

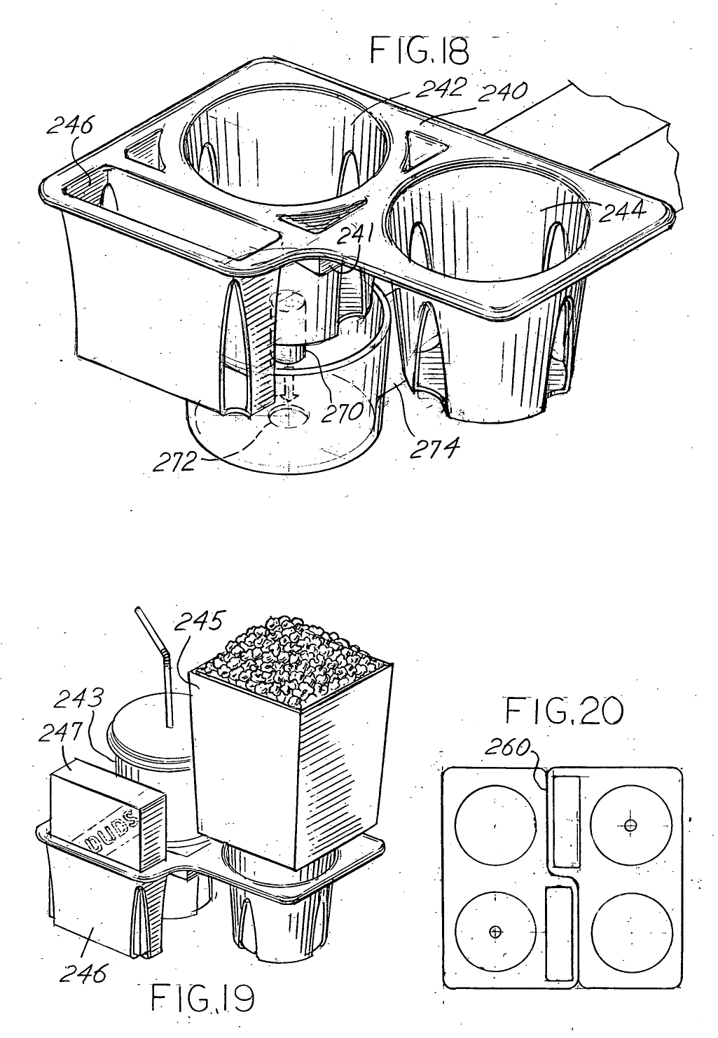

FIGS. 18-20 illustrate yet a further embodiment of the invention. A web 240 includes a cup section 242, a second cup section 244 and a snack or box receiving section 246. As shown in FIG. 19, the cup section 242 may receive a cup 243. A second section 244 may receive a food container such as a popcorn container 245 and the third section 246 may receive a box of snacks, box 247. The orientation of the various elements is such that the container 242 will serve to be placed in an arm rest of a seat, whereas the section 246 may fit over front arm of the seat and the section 244 will extend laterally from the seat. FIG. 20 illustrates the manner in which two such embodiments of the type shown in FIG. 18 may be physically molded or made with a separation line 260. In the tray represented by FIG. 20 may be used as a serving tray when entertaining or may be used as described to provide for placement in a cup holder to hold snack items.

Referring to FIG. 18, the bottom of the cup container 242 may include a downwardly projecting peg or extension 270 which will fit into passage 272 normally provided in cup holders in theatre seat arms 274. The peg or projection 270 from the bottom surface of the cup holder 242 thus fits within the opening 272 to facilitate maintenance of balance and placement of the tray. This concept may be employed in any of the embodiments heretofore described.

Again, referring to FIG. 18, depressions or depending molded forms 241 may be incorporated in the web 240 to hold the tray a fixed distance from an arm or cup holder and to facilitate balance as well as reinforce the tray. One or more formed depressions 241 may be molded or formed.

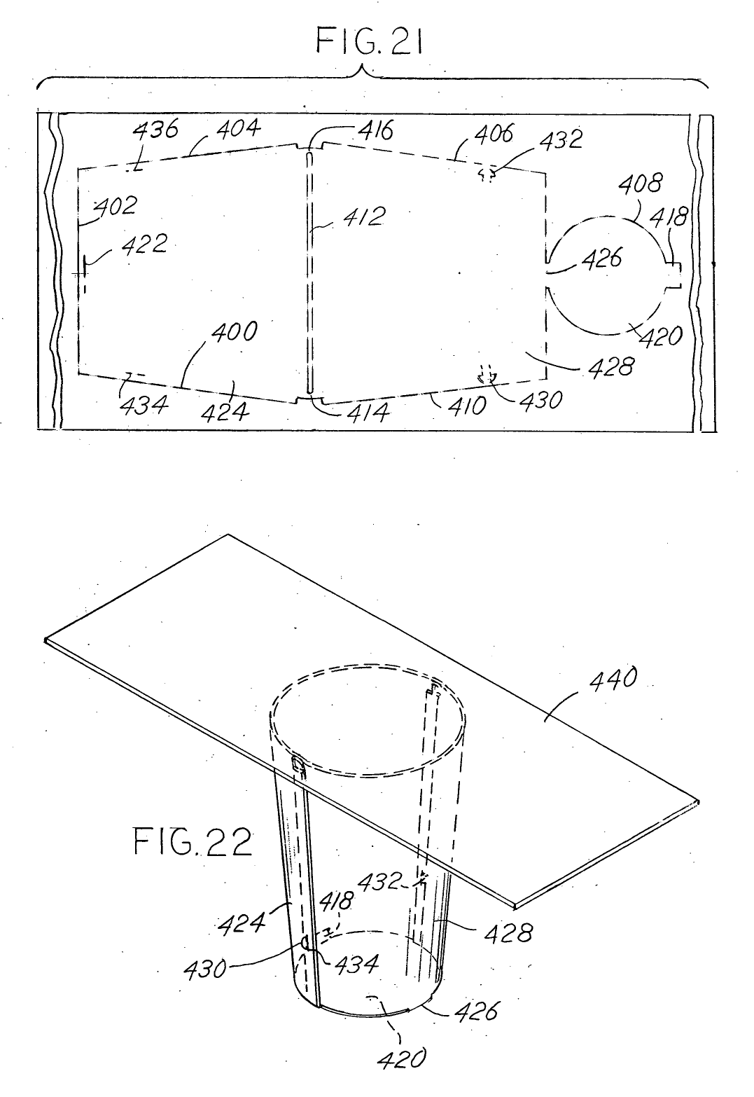

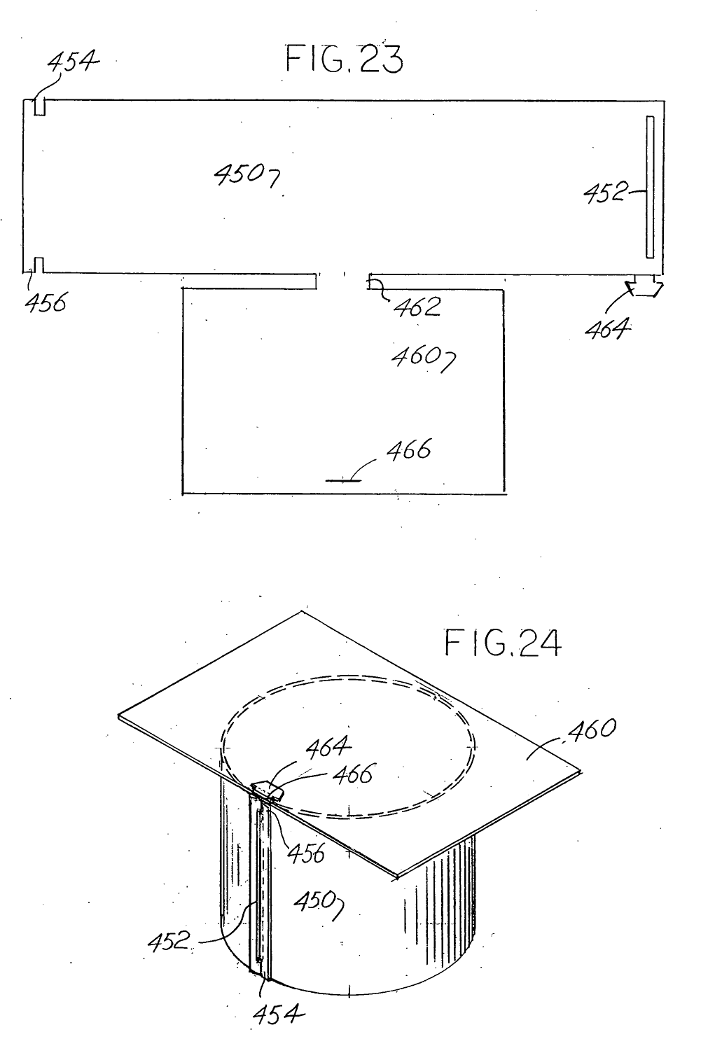

FIGS. 21-22 and FIGS. 23-24 depict a variation or embodiment that provides a generally planar tray supported by a cup shaped lower section wherein the embodiments are formed from a flat sheet of die cut material such as cardboard stock. Referring to FIGS. 21-22 the flat stock in the form of a rectangular sheet is die cut along dotted lines 400, 402, 404, 406, 408 and 410. The center section 412 of the stock is also cut having a flexible hinge section 414, 416 on each side thereof. Tabs 418 are provided on a bottom side 420 to engage slot 422 cut in flap or semi-cylindrical section. The bottom side 420 is attached along a fold 426 to flap or semi-cylindrical section 428. Tabs 430, 432 at the edges of semi-cylindrical section 428 engage slots 434, 436 respectively when the flaps 424, 428 are folded as shown in FIG. 23 to form a truncated cup shape with a bottom side 420 supporting a flat planar tray 440. Thus, the formed cup will fit into a cup holder and the tray 440 will support snacks, etc.

FIGS. 23-24 illustrate a variation or alternative to the embodiment of FIGS. 21-22. In FIGS. 23-24 flat stock is die cut with an elongate rectangular or nearly rectangular lower section 450 having a slot 452 for receipt of end tabs 454, 456 when section 450 is folded or formed as a cylinder. An upper rectangular tray section 460 is attached by a side hinge element or connection 462 to a side edge of section 450. A locking tab 464 formed on the opposite side of section 450 may be fitted through a slot 466 in the side of upper tray section 460 to complete the folding of the die cut flat stock to the form of FIG. 24 where the lower section 450 will fit into a cup holder and the upper section 460 forms a tray.

As previously mentioned, any or all of the various designs may be manufactured as molded plastic products and any one of the designs may include indicia, such as writing instructions, etc. on the outside of the container portion. Further, any or all of the embodiments may include coating on the interior side. Further, the base container may serve as a portion or part of the interior of the combination cup shaped base and container for storage of a portion of the snack food element. However, in the preferred embodiments, the base is a separate element attached to a panel of a container in order to enable the container to be placed in a cup holder. The particular shape of the base may thus be varied also, e.g. downwardly, be pending prongs or legs may be used, for example. The containers may include a separate liner or a liner which compartmentalizes the container into multiple sections for different snacks. The container may also include an insert which will receive and hold a cup with the remainder of the container for the purpose of placement of a snack therein.

Thus, while there has been set forth a preferred embodiment of the invention, it is to be understood that the invention is limited only by the following claims and equivalents thereof.

What is claimed is:

1. A snack container comprising, in combination:
a generally truncated cylindrical lower support section having an upper, generally circular rim; and
an upper snack container including a generally planar bottom side having an inside and an outside, a closed loop lateral side attached about a lower periphery to the bottom side, said support section circular rim attached to the outside of the bottom side.

2. The container of claim 1 wherein the upper snack container includes a lining.

3. The container of claim 1 wherein the lower section is adhered to the bottom side by at least one double sided adhesive strip.

4. The container of claim 1 wherein the upper container is a truncated cylinder shape with an open top and is generally co-axial with the support section.

5. The container of claim 1 wherein the upper container is a polyhedral shape.

6. The container of claim 1 wherein the bottom side includes an opening aligned with the opening of the lower section within the circumference of the rim.

7. The container of claim 1 wherein the upper container includes an expandable cover.

8. The container of claim 1 wherein the upper container comprises a foldable bag.

9. The container of claim 1 wherein the upper container includes unpopped microwave pop corn.

10. The container of claim 1 wherein the upper container includes a removable cover.

11. A snack container comprising, in combination:
a generally truncated, cylindrical support element having a top rim,
a tray attached to the top rim, said tray projecting generally laterally from the top rim and including at least one depending receptacle opening adjacent the support element.

12. The container of claim 11 wherein the tray includes at least one generally planar section projecting laterally from the support element below the rim to thereby form a retention groove for the container.

13. The container of claim 11 including at least two tray sections forming the tray, said sections projecting laterally from the support element and generally below the rim to form a groove in the tray.

14. The container of claim 11 wherein the support element includes a depending lug for engaging a passage in the bottom of a cup holder.

15. The container of claim 11 wherein the tray comprises a generally horizontal section projecting from the rim and including at least two recess counterbore openings for holding an item and said support element has an opening through the circular rim, said support element formed to hold a food item.

16. A snack container comprising, in combination:
a lower support section including a truncated cylindrical cup with a generally circular top rim, a lateral side, a generally closed top, and an adhesive element; said lower support section including an axis of rotation; and
an upper snack container section having a bottom side, lateral side, an open top, and an axis of symmetry, said axes aligned, said adhesive element affixed to the bottom of the upper container section, said bottom side having a greater area than the top side of the support section.

17. The container of claim 16 further including a top cover for the open top of the upper container section.

18. The container of claim 17 further including an expandable top cover.

19. The container of claim 16 wherein the upper container section comprises a truncated cylinder having a bottom side.

20. The container of claim 1 wherein the upper container section comprises a truncated cylinder having a bottom side generally congruent with the circular rim.

21. The container of claim 20 wherein the upper container section is comprised of a truncated cylinder having an upper rim defining an area greater than the area defined by the circular rim.

22. The container of claim 11 wherein the tray extends laterally from the top rim.

23. The container of claim 11 wherein the tray covers the depending opening, said tray comprising a generally flat planar support surface.

24. The container of claim 11 wherein the container support element and tray are formed from cut flat stock folded to form said support element and tray in a single piece.

25. The container of claim 24 wherein the tray covers the support element.

26. The container of claim 24 wherein the tray includes an opening about the top rim of the support element.

27. A container combination including a lower base element capable of fitting into a holder designed to receive a generally cylindrical cup and an upper container section having a configuration and shape with a cross sectional profile greater in area than that of the base element and providing a container for prepared or unprepared snack food.
